(19) United States
(12) Patent Application Publication
(10) Pub. No.: US 2001/0011004 A1
(43) Pub. Date: Aug. 2, 2001

(54) Grinding wheel and production process therefor

(76) Inventors: Takakazu Yamaguchi, Tokyo (JP); Nobuaki Oshita, Tokyo (JP)

Correspondence Address: Beveridge, DeGrandi, Weilacher & Young, Suite 800, 1850 M Street, N.W., Washington, DC, 20036, US

(21) Appl. No.: 09/768,366

(22) Filed: Jan. 25, 2001

(30) Foreign Application Priority Data
Jan. 28, 2000 (JP) 2000-20129

(51) Int. Cl. B23F 21/03

(52) U.S. Cl. 451/548

(57) ABSTRACT

A grinding wheel comprises an annular support member and a grinding member arranged on one side of the support member. A groove is formed in one side of the support member. The grinding member is formed by molding an unsintered body, obtained by mixing abrasive grains and a bonding material, into an unsintered body having a buried portion for filling the groove and a protrusion portion protruding from the grove and sintering the unsintered body.

### FIELD OF THE INVENTION

The present invention relates to a grinding wheel which can be advantageously used to grind the rear surface of a semiconductor wafer and which comprises an annular support member and a grinding member arranged on one side of the support member; and to a process for producing this grinding wheel.

### DESCRIPTION OF THE PRIOR ART

As is known among people skilled in the art, a grinding wheel which comprises an annular support member and a plurality of grinding members arranged on one side (generally an under surface) of the annular support member is advantageously used as a tool for grinding the rear surface of a semiconductor wafer. The support member is made of an appropriate metal such as aluminum, and an annular groove is formed in one side thereof, extending continuously in the circumferential direction. The grinding members are each formed by mixing abrasive grains such as diamond grains and a bonding material, compression molding the obtained mixed material into a circular arc form, and sintering it. The grinding members are installed in the groove formed in the support member with some space therebetween. More specifically, the base portion of each grinding member is inserted into the groove in the support member and bonded to the groove by an appropriate adhesive to mount the grinding members in the support member. The main portion of each grinding member protrudes from the groove. The support member of the grinding wheel is fixed to the end of a rotary spindle and rotated at a high speed together with the rotary spindle. The grinding members of the grinding wheel which is rotated at a high speed are pressed against the rear surface of the semiconductor wafer to be ground, whereby the rear surface of the semiconductor wafer is ground by the grinding members.

However, the grinding wheel of the prior art involves the following problems: (1) the grinding members may come off from the support member, though it is rare, because the adhesion of the grinding members to the groove in the support member is not sufficiently strong, and (2) a plurality of grinding members mounted on the support member are not always uniform in quality as the grinding members are formed separately and independently, and abrasion of the grinding members used may therefore differ from one another.

### SUMMARY OF THE INVENTION

It is therefore a principal object of the present invention to provide a novel and improved grinding wheel which is free from the above problems existent in the grinding wheel of the prior art.

The inventors of the present invention have conducted intensive studies and have found that the above principal object can be attained by forming a mixed material by mixing abrasive grains and a bonding material, molding the mixed material into an unsintered body having a buried portion for filling a groove in the support member and a protrusion portion protruding from the groove, and sintering the unsintered body, thereby forming a grinding member at a predetermined position on the support member.

That is, according to an aspect of the present invention, there is provided a grinding wheel which comprises an annular support member and a grinding member arranged on one side of the support member as a grinding wheel for attaining the above principal object, wherein

a groove is formed in the one side of the support member; and

the grinding member is formed by molding a mixed material, prepared by mixing abrasive grains and a bonding material, into an unsintered body having a buried portion for filling the groove and a protrusion portion protruding from the groove, and sintering the unsintered body.

According to another aspect of the present invention, there is provided a process for producing a grinding wheel which comprises an annular support member and a grinding member arranged on one side of the support member as a grinding wheel production process for attaining the above principal object, which comprises the steps of:

forming the annular support member having a groove in one side;

molding a mixed material, prepared by mixing abrasive grains and a bonding material, into an unsintered body having a buried portion for filling the groove and a protrusion portion protruding from the groove; and

sintering the unsintered body to form the grinding member.

In a preferred embodiment of the present invention, the unsintered body is formed by mixing abrasive grains and a bonding material and then, heating and compressing the mixed material. The groove has an annular form extending continuously in the circumferential direction, and at least the buried portion of the grinding member may also be of an annular form extending continuously in the circumferential direction. Preferably, the groove has a bottom wall and both side walls, and a depressed portion is formed in at least one of the both side walls. The depressed portion is an annular depressed portion extending continuously in the circumferential direction and defined by a first inclined surface which is inclined outwardly toward the bottom wall and a second inclined surface which extends continues to the first inclined surface and is inclined inwardly toward the bottom wall. The inclination angle α of the first inclined surface with respect to the center line of the groove preferably satisfies 45°<α<90° and the inclination angle β of the second inclined surface with respect to the center line of the groove preferably satisfies 0°<β<45°. A plurality of slits may be formed at intervals in the circumferential direction in the protrusion portion of the grinding member. The abrasive grains may be diamond grains and the bonding material may be a resin bond. The concentration of the abrasive grains is preferably 50 to 200. The support member may be made of aluminum. To form the unsintered body, jigs are used to define a protrusion portion-defining groove extending from the groove in the support member, the unsintered body fills the groove and at least part of the protrusion portion-defining groove, the unsintered body is sintered to form the grinding member, and the jigs are removed from the grinding member. Alternatively, addition portions for defining the protrusion portion-defining groove extending from the groove are formed integrated with the support member, the unsintered body fills the groove and at least part of the protrusion portion-defining groove, the unsintered body is sintered to form the grinding member, and then the addition portions of the support member are removed. The unsintered body can be formed by mixing abrasive grains and a bonding material, then heating the obtained mixed material at a temperature of 60 to 190° C. for 5 to 15 minutes and compressing it at a pressure of 1 to 30 MPa. The unsintered body can be sintered by being heated at 150 to 200° C. for 15 to 20 hours.

### BRIEF DESCRIPTION OF THE DRAWINGS

FIG. 1 is a perspective view of a grinding wheel according to a preferred embodiment of the present invention;

FIG. 2 is a perspective view of the grinding wheel of FIG. 1 in an upside-down state;

FIG. 3 is a partially enlarged sectional view of the grinding wheel of FIG. 1;

FIGS. 4 and 5 are schematic views for explaining a process for producing the grinding wheel shown in FIG. 1 according to a preferred embodiment of the present invention; and

FIGS. 6 and 7 are schematic views for explaining a modified embodiment of the process for producing the grinding wheel shown in FIG. 1 according to the embodiment of the present invention.

### DETAILED DESCRIPTION OF THE PREFERRED EMBODIMENTS

Preferred embodiments of the present invention will be described in detail hereinafter with reference to the accompanying drawings.

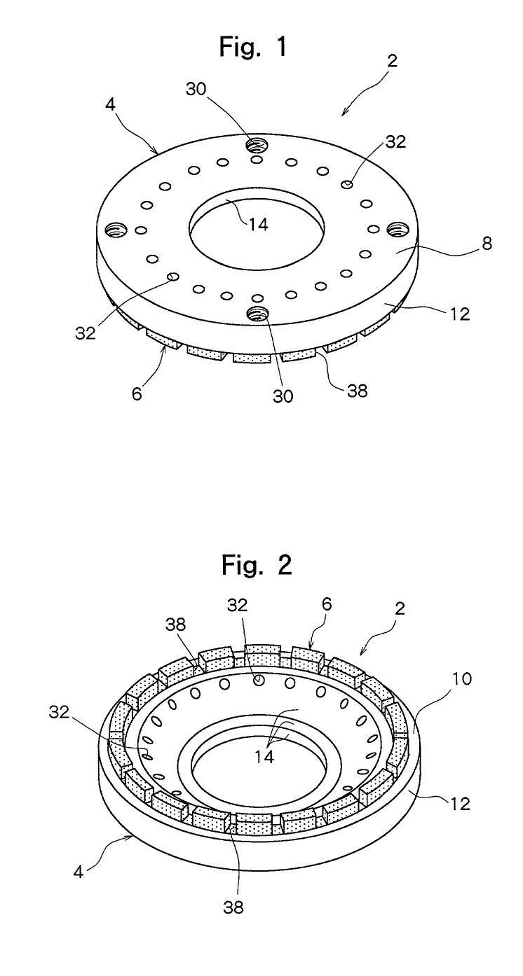

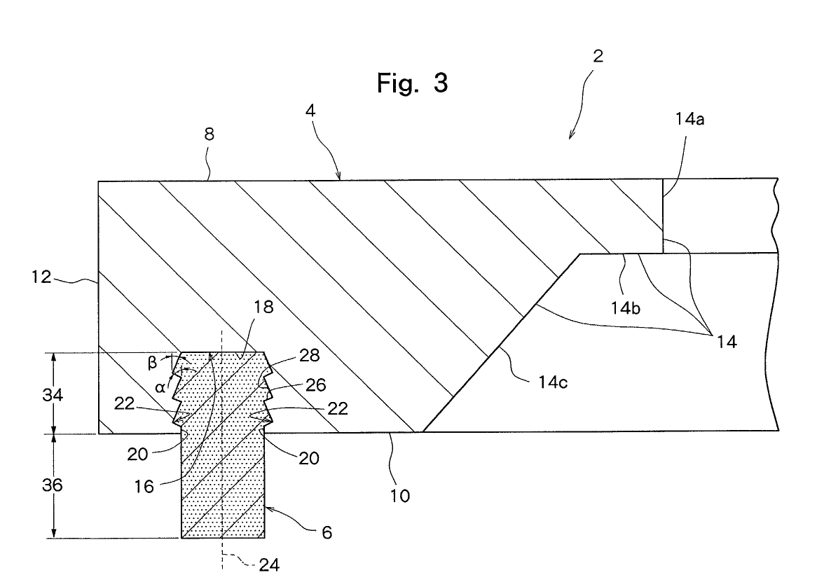

FIGS. 1 to 3 show a grinding wheel according to a preferred embodiment of the present invention. The grinding wheel denoted by numeral 2 as a whole comprises a support member 4 and a grinding member 6.

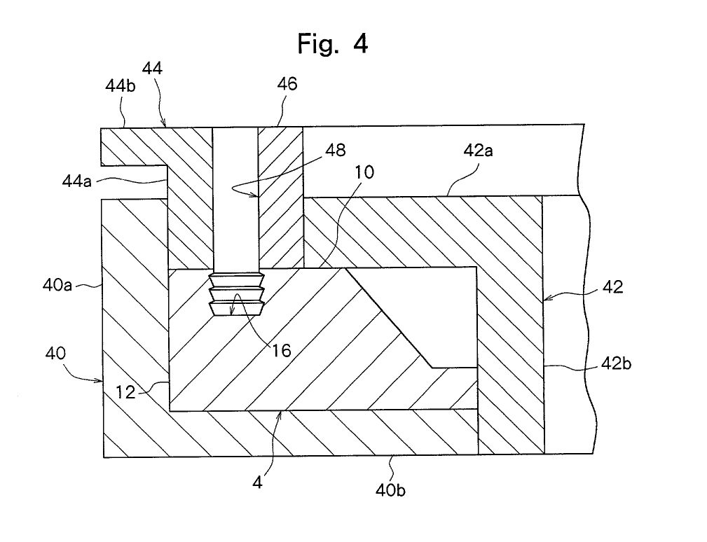

The support member 4 which can be formed out of an appropriate metal such as aluminum or stainless steel is annular as a whole and has a top surface 8, an under surface 10, an outer circumferential surface 12 and an inner circumferential surface 14. The top surface 8 is a flat surface extending substantially horizontal and the under surface 10 is also a flat surface extending substantially horizontal and in parallel to the top surface 8. The outer circumferential surface 12 is shaped like a substantially vertical cylinder. The inner circumferential surface 14 consists of a substantially vertical cylindrical portion 14a, an annular flat portion 14b extending substantially horizontal, and a truncated cone-like portion 14c whose diameter increases toward the lower end thereof. An annular groove 16 extending continuously in the circumferential direction is formed in the under surface 10. The groove 16 has a bottom wall 18 and both side walls 20. Depressed portion 22 is suitably formed in at least one of the both side walls 20. In the illustrated embodiment, three depressed portions 22 are formed in each of the both side walls 20. Each of the depressed portions 22 is defined by a first inclined surface 26 which is inclined outwardly toward the bottom wall 18 (therefore inclined upwardly in a direction that it parts from the center line 23 of the groove 16) and by a second inclined surface 28 which is inclined inwardly toward the bottom wall 18 (therefore inclined upwardly in a direction that it approaches the center line 23 of the groove 16) in the section shown in FIG. 3. Each of the depressed portions 22 has an annular form extending continuously in the circumferential direction, the first inclined surface 26 is shaped like an inverted truncated cone whose diameter gradually increases toward the upper end thereof as a whole, and the second inclined surface 28 is shaped like a truncated cone whose diameter gradually decreases toward the upper end thereof as a whole. The inclination angle α of the first inclined surface 26 with respect to the center line 23 of the groove 16 preferably satisfies 45°<α<90° and the inclination angle β of the second inclined surface 28 with respect to the center line 23 of the groove 16 preferably satisfies 0°<β<45°.

In the illustrated embodiment, a plurality of blind holes 30 (FIG. 1) extending downward from the top surface 8 are formed in the support member 4 at the same angular intervals and threaded. A plurality of through holes 32 extending from the top surface 8 to the lower end portion of the truncated cone-like portion 14c of the inner circumferential surface 14 are formed at the same angular intervals in the circumferential direction. As is known, fastening screws (not shown) are driven into the blind holes 30 to mount the grinding wheel 2 to the lower end of a rotary spindle (not shown). When the rear surface of a semiconductor wafer is ground by applying the grinding member 4 of the grinding wheel 2 to the rear surface of the semiconductor wafer (not shown) while the rotary spindle having the grinding wheel 2 mounted thereto is rotated at a high speed, a cooling liquid which may be pure water is flowed out from the through holes 32.

The grinding member 6 in the illustrated embodiment has an annular form extending continuously in the circumferential direction and has a buried portion 34 which is situated in the groove 16 formed in the support member 4 and a protrusion portion 36 which protrudes from the groove 16. The buried portion 34 completely fills the groove 16, and the cross sectional form of the buried portion 34 of the grinding member 6 is the same as the cross sectional form of the groove 16. The protrusion portion 36 of the grinding member 6 has a rectangular cross sectional form and the top surface thereof is a flat surface extending substantially horizontal. A plurality of slits 38 are preferably formed in the protrusion portion 36 of the grinding member 6 at intervals in the circumferential direction. Each of the slits 38 extends substantially vertically from the top surface of the protrusion portion 36 to the under surface of the support member 4 (therefore to the proximal end of the protrusion portion 36).

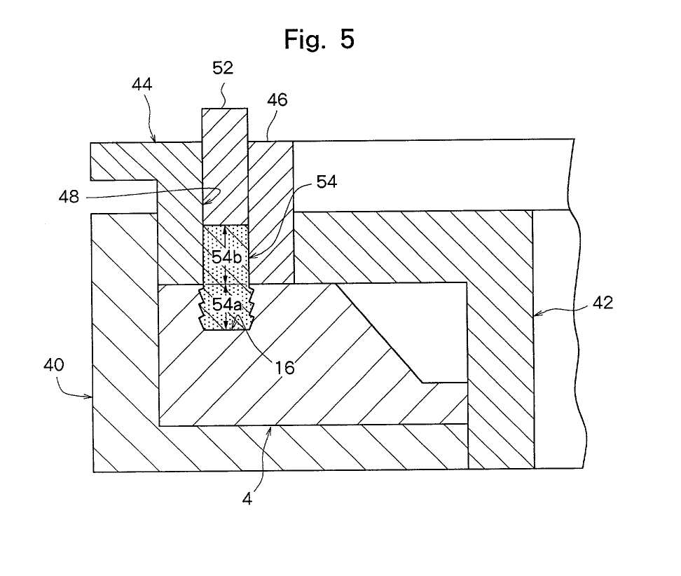

In the grinding wheel 2 constituted according to the present invention, it is important that the grinding member 6 should be formed by mixing abrasive grains and a bonding material to prepare a mixed material, molding the mixed material into an unsintered body having a buried portion for filling the groove 16 in the support member 4 and a protrusion portion protruding from the groove 16, and sintering this unsintered body. Describing a preferred example of a process for producing the grinding wheel 2 described above, a metal material is first machined properly to form a support member 4 shown in FIGS. 1 to 3. As shown in FIG. 4, auxiliary jigs 40 and 42 are combined with the support member 4 positioned in an upside-down state (that is, in an inverted state). The auxiliary jig 40 has a cylindrical portion 40a and an annular plate portion 40b. The cylindrical portion 40a extends along the outer circumferential surface 12 of the support member 4, and the free end portion of the cylindrical portion 40a protrudes from the under surface 10 of the support member 4. The auxiliary jig 42 has an annular plate portion 42a and a cylindrical portion 42b, and the free end portion of the annular plate portion 42a is positioned on the inner side portion of the under surface 10 of the support member 4. Jigs 44 and 46 are further combined with the support member 4. The jig 44 has a cylindrical portion 44a and an annular plate portion 44b, and the outer circumferential surface of the cylindrical portion 44a is brought into close contact with the inner circumferential surface of the free end portion of the cylindrical portion 40a of the auxiliary jig 40. The jig 46 is cylindrical and the inner circumferential surface thereof is brought into close contact with the top end surface of the annular plate portion 42a of the auxiliary jig 42. As clearly shown in FIG. 4, a protrusion portion-defining groove 48 extending from the groove 16 formed in the support member 4 is defined between the jigs 44 and 46. Thereafter, as shown in FIG. 5, a mixed material obtained by mixing abrasive grains and a bonding material is charged into the groove 16 and the protrusion portion-defining groove 48 to fill the groove 16 and at least part of the protrusion portion-defining groove 48. The mixed material is heated for a predetermined time and compressed by using a hollow cylindrical pressing tool 52 having a cross sectional form corresponding to the cross sectional form of the protrusion portion-defining groove 48 to form an unsintered body 54 having a buried portion 54a for filling the groove 16 and a protrusion portion 54b protruding from the groove 16.

The abrasive grains to be mixed with the bonding material to form the unsintered body are preferably diamond grains. The bonding material may be an appropriate resin bond. The concentration of the abrasive grains is preferably 50 to 200. When the mixed material consists of diamond grains and a resin bond, it is preferably compressed at a pressure of 1 to 30 MPa while it is heated at a temperature of 60 to 190° C. for 5 to 15 minutes to be molded into the unsintered body 54 having a desired form. After the unsintered body 54 is formed, it is sintered by being heated, for example, at 150 to 200° C. for 15 to 20 hours to form the grinding member 6. Thereafter, the jigs 44 and 46 and the auxiliary jigs 40 and 42 are removed from the support member 4. The protrusion portion 36 of the formed grinding member 5 is machined to form a plurality of slits 38, thereby producing the grinding wheel 2.

In the above-described grinding wheel 2, the grinding member 6 is formed by first forming the unsintered body 54 having the buried portion 54a for filling the groove 16 in the support member 4 and then sintering the unsintered body 54. Therefore, the grinding member 6 can be firmly bonded to the support member 4. The depressed portions 22 formed in the groove 16 mechanically fix the grinding member 6 to the groove 16 in the support member 4 thereby to increase the bonding strength of the grinding member 6 to the support member 4. Since the whole grinding member 6 is formed as a single unit, it can be formed fully uniform in quality.

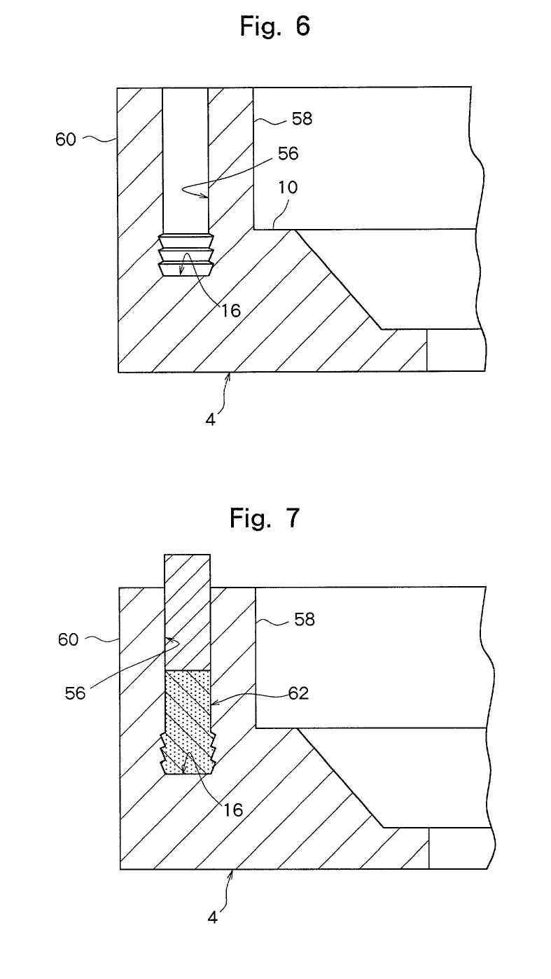

FIGS. 6 and 7 show a modification of the process for producing the grinding wheel 2 shown in FIGS. 1 to 3. In this modification, addition portions 58 and 60 for defining the protrusion portion-defining groove 56 extending from the groove 16 are formed integrated with the under surface 10 of the support member 4. The mixed material, prepared by mixing abrasive grains and a bonding material, is filled into the groove 16 and the protrusion portion-defining groove 56 to form an unsintered body 62 and then, the unsintered body 62 is sintered to form the grinding member 6. Thereafter, the addition portions 58 and 60 formed on the support member 4 are removed by etching or appropriate machining. The production process illustrated in FIGS. 6 and 7 may be substantially the same as the production process illustrated in FIGS. 4 and 5 except that the support member 4 having the addition portions 58 and 60 is used in place of using the holding jigs 40 and 42 and the jigs 44 and 46.

While preferred embodiments of the invention have been described in detail with reference to the accompanying drawings, it is to be understood that the invention is not limited to these embodiments and that various changes and modifications may be made in the invention without departing from the spirit and scope thereof.

What is claimed is:

1. A grinding wheel comprising an annular support member and a grinding member arranged on one side of the support member, wherein
a groove is formed in the one side of the support member; and
the grinding member is formed by molding a mixed material, prepared by mixing abrasive grains and a bonding material, into an unsintered body having a buried portion for filling the groove and a protrusion portion protruding from the groove, and sintering the unsintered body.

2. The grinding wheel of claim 1, wherein the unsintered body is formed by mixing abrasive grains and a bonding material and then, heating and compressing the mixed material.

3. The grinding wheel of claim 1, wherein the groove has an annular form extending continuously in the circumferential direction, and at least the buried portion of the grinding member has also an annular form extending continuously in the circumferential direction.

4. The grinding wheel of claim 3, wherein the groove has a bottom wall and both side walls, and a depressed portion is formed in at least one of the both side walls.

5. The grinding wheel of claim 4, wherein the depressed portion is an annular depressed portion extending continuously in the circumferential direction and defined by a first inclined surface which is inclined outwardly toward the bottom wall and a second inclined surface which extends continuous to the first inclined surface and is inclined inwardly toward the bottom wall, the inclination angle α of the first inclined surface with respect to the center line of the groove satisfies 45°<α<90°, and the inclination angle β of the second inclined surface with respect to the center line of the groove satisfies 0°<β<45°.

6. The grinding wheel of claim 1, wherein a plurality of slits are formed in the protrusion portion of the grinding member at intervals in the circumferential direction.

7. The grinding wheel of claim 1, wherein the abrasive grains are diamond grains and the bonding material is a resin bond.

8. The grinding wheel of claim 7, wherein the concentration of the abrasive grains is 50 to 200.

9. The grinding wheel of claim 1, wherein the support member is made of aluminum.

10. A process for producing a grinding wheel which comprises an annular support member and a grinding member arranged on one side of the support member, comprising the steps of:
forming the annular support member having a groove in one side;
molding a mixed material, prepared by mixing abrasive grains and a bonding material, into an unsintered body having a buried portion for filling the groove and a protrusion portion protruding from the groove; and
sintering the unsintered body to form the grinding member.

11. The process of claim 10, wherein the unsintered body is formed by mixing abrasive grains and a bonding material and then, heating and compressing the mixed material.

12. The process of claim 11, wherein when the unsintered body is to be formed, jigs are used to define a protrusion portion-defining groove extending from the groove in the support member, the sintered body fills the groove and at least part of the protrusion portion-defining groove and is sintered to form the grinding member, and then the jigs are removed from the grinding member.

13. The process of claim 11, wherein addition portions for defining the protrusion portion-defining groove extending from the groove are formed integrated with the support member, the unsintered body fills the groove and at least part of the protrusion portion-defining groove and is sintered to form the grinding member, and then the addition portions of the support member are removed.

14. The process of claim 10, wherein the groove has an annular form extending continuously in the circumferential direction, and the buried portion and the protrusion portion of the unsintered body have each also an annular form extending continuously in the circumferential direction.

15. The process of claim 10, wherein the groove has a bottom wall and both side walls, and a depressed portion is formed in at least one of the both side walls.

16. The process of claim 15, wherein the depressed portion is an annular depressed portion extending continuously in the circumferential direction and defined by a first inclined surface which is inclined outwardly toward the bottom wall and a second inclined surface which extends continuous to the first inclined surface and is inclined inwardly toward the bottom wall, the inclination angle α of the first inclined surface with respect to the center line of the groove satisfies 45°<α<90°, and the inclination angle β of the second inclined surface with respect to the center line of the groove satisfies 0°<β<45°.

17. The process of claim 10, wherein a plurality of slits are formed in the protrusion portion at intervals in the circumferential direction after the unsintered body is sintered.

18. The process of claim 11, wherein the abrasive grains are diamond grains and the bonding material is a resin bond.

19. The process of claim 18, wherein the concentration of the abrasive grains is 50 to 200.

20. The process of claim 18, wherein the unsintered body is formed by mixing abrasive grains and a bonding material and then, heating and compressing the mixed material at a temperature of 60 to 190° C. for 5 to 15 minutes and at a pressure of 1 to 30 MPa.

21. The process of claim 18, wherein the unsintered body is sintered by heating at 150 to 200° C. for 15 to 20 hours.

22. The process of claim 10, wherein the support member is made of aluminum.
